(19) United States
(12) Patent Application Publication
(10) Pub. No.: US 2023/0044003 A1
(43) Pub. Date: Feb. 9, 2023

(54) REEL SEAT FOR USE WITH A FISHING ROD

(71) Applicant: Chi Huynh, San Dimas, CA (US)

(72) Inventor: Chi Huynh, San Dimas, CA (US)

(21) Appl. No.: 17/461,475

(22) Filed: Aug. 30, 2021

Related U.S. Application Data
(60) Provisional application No. 63/230,062, filed on Aug. 6, 2021.

(51) Int. Cl. A01K 87/06

(52) U.S. Cl. CPC A01K 87/06

(57) ABSTRACT

A reel seat for use with a fishing rod, the reel seat including a hollow body; a receiving member shaped to receive a foot of a fishing reel; an adjusting mechanism positioned within the hollow body, the adjusting mechanism configured to move the receiving member longitudinally to capture and release the fishing reel; and an actuator that actuates the adjusting mechanism, wherein the actuator is positioned outside of the hollow body.

### CROSS REFERENCE TO RELATED APPLICATIONS

This application claims benefit of priority to U.S. provisional patent application No. 63/230,062, filed Aug. 6, 2021.

### TECHNICAL FIELD

The invention relates to fishing rod components and more specifically to a reel seat for use with a fishing rod having an adjusting mechanism positioned inside and therefore substantially hidden from view within a hollow body, the adjusting mechanism configured to move a receiving member longitudinally to reversibly mount a fishing reel.

### BACKGROUND OF THE INVENTION

Fishing rods and reels have long been known in the art. It is also well known that fishing reels can be interchanged between different fishing rods. Fishing reels are conventionally mounted to fishing rods by way of a reel seat.

Since fishing reels add substantial weight to the fishing rod, anglers frequently hold the fishing rod at the reel seat. However, mechanisms that form conventional real seats are outwardly exposed and therefore tend to press against the hands while gripping the fishing rod. Over time, gripping such mechanisms can lead to hand injury or at least discomfort. Accordingly, there remains a need to provide a more ergonomic reel seat that is more comfortable to grip over extended periods of time.

### BRIEF SUMMARY OF THE INVENTION

The invention addresses the above challenges and provide related benefits. In particular, the invention provides a reel seat that is more comfortable to handle over long periods of time. The above is achieved in one aspect of the invention by a reel seat for use with a fishing rod, which includes: a hollow body; a receiving member shaped to receive a foot of a fishing reel; an adjusting mechanism positioned within the hollow body, the adjusting mechanism configured to move the receiving member longitudinally to capture or release the fishing reel; and an actuator that actuates the adjusting mechanism, the actuator being positioned outside of the hollow body.

In some embodiments the hollow body is configured for attachment to a fishing rod blank to form a fishing rod. In further embodiments the hollow body forms a handle of the fishing rod.

In some embodiments, the adjusting mechanism includes a threaded rod configured to rotate within the hollow body and a complementary threaded rail coupled to the receiving member or forming part of the receiving member so that the receiving member moves longitudinally when the threaded rod is rotated. In some embodiments the threaded rod is rotatably coupled at one end of the hollow body by means of a pin and sleeve. In some embodiments the threaded rod is rotatably coupled at an opposing end by way of a cap with aperture. In some embodiments the threaded rod is fixedly coupled to the actuator at one end, In some embodiments the actuator includes an extension fixedly attached to a grip.

In a related aspect of the invention a method of securing a fishing reel to the reel seat is provided, the method including positioning a fishing reel so that the fishing reel foot is aligned for receipt by the receiving member; and moving the receiving member longitudinally against the foot of the fishing reel. In some embodiments, the method includes rotating a threaded rod by way of an actuator so that the receiving member, which includes a complementary threaded rail, moves longitudinally against the foot of the fishing reel.

### BRIEF DESCRIPTION OF THE DRAWINGS

Embodiments of the invention can be better understood with reference to the following drawings, which form part of the specification and represent preferred but non-limiting embodiments. The components in the drawings are not necessarily to scale, emphasis instead being placed upon illustrating the principles of the invention. And, in the drawings, like reference numerals designate corresponding parts throughout the several views.

FIG. 1 depicts a fishing rod with a conventional reel seat.

FIG. 2 depicts a fishing rod with an exemplary reel seat as set forth in the invention.

FIG. 3 is a side elevational view of the exemplary reel seat.

FIG. 4 is side cutaway view of a fishing rod with the exemplary reel seat.

FIG. 5 is an enlarged view of the embodiment shown in FIG. 4.

FIG. 6 is an isometric cutaway view of the exemplary reel seat.

FIG. 7 is an exploded view of the exemplary reel seat.

FIG. 8 is a bottom view of the exemplary reel seat.

FIG. 9 is an isometric view of the exemplary reel seat.

FIG. 10 are front and rear views of the exemplary reel seat

### DETAILE DESCRIPTION OF PREFERRED EMBODIMENTS

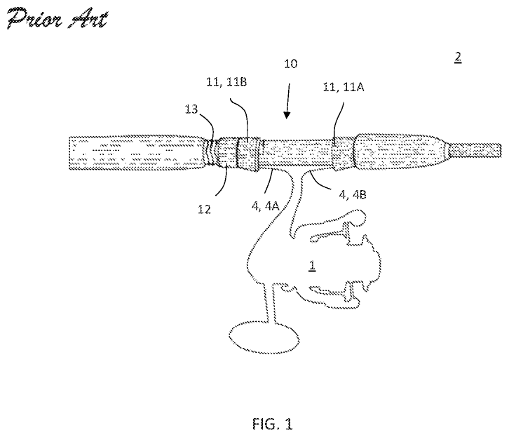

For clarity of disclosure, and not by way of limitation, the invention is discussed according to different detailed embodiments; however, the skilled artisan would recognize that features of one embodiment can be combined with other embodiments and is therefore within the intended scope of the invention. Beginning now at FIG. 1, it is well known in the art that fishing reels 1 are conventionally joined to fishing rods 2 through a reel seat 10. Reel seats 10 typically have two flanged rings 11A, 11B, most often a fixed ring 11A and a movable ring 11B, which are sized to fit over the foot 4 of the fishing reel 1. In such instances, one side of the foot 4A is inserted underneath the fixed ring 11A, then the movable ring 11B is brought over the opposing side of the foot 4B by rotating an outer nut 12 around an exposed thread 13 formed around the perimeter of the rod 2 so that the outer nut 12 pushes the moveable ring 11B snuggly over the foot 4. Removing the reel 1 is performed by unwinding the outer nut 12 so that the movable ring 11B can be retracted and thus the foot 4 removed.

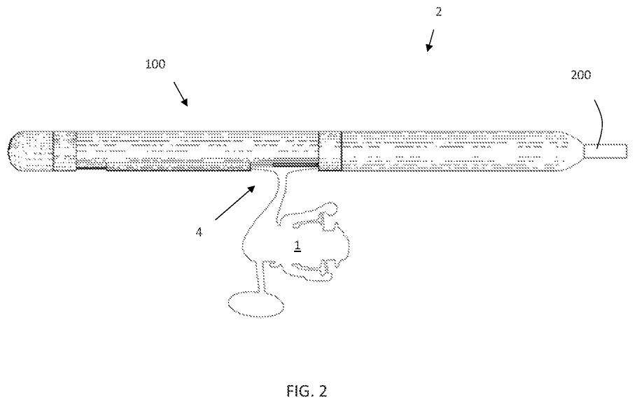

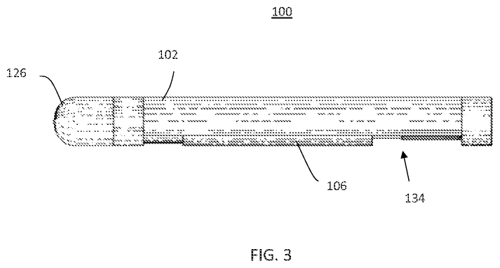

Comparing FIG. 2 to FIG. 1, the invention provides an improved reel seat 100 that no longer requires the rotation of an outer nut 12 around an exposed thread 13. By removing the outer nut 12 and exposed thread 13, the angler can handle the fishing rod 2 more comfortably. In particular, pain or discomfort commonly felt when squeezing the outer nut 12, exposed thread 13 and/or flanged rings 11 against the angler's gripping hand is eliminated. Through the development of an improved reel seat 100, the ergonomics are such that it can be gripped for prolonged periods of time while significantly reducing pain or discomfort. As shown more clearly in FIG. 3, the improved reel seat 100 can be substantially cylindrical, with or without padding. Compared again to FIG. 1, the reel seat 100 can be sculpted for still further ergonomics without the constraints of an outer nut 12 and exposed thread 13.

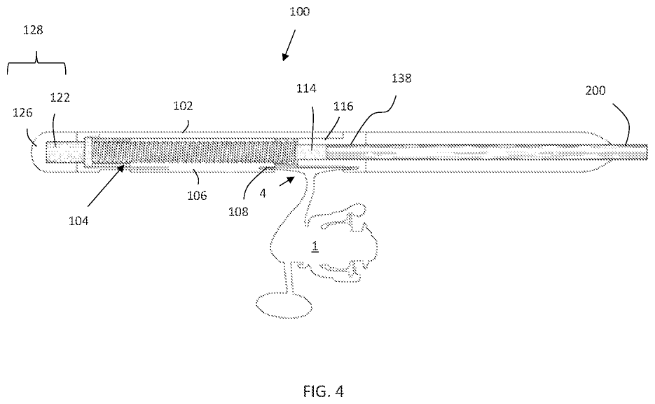

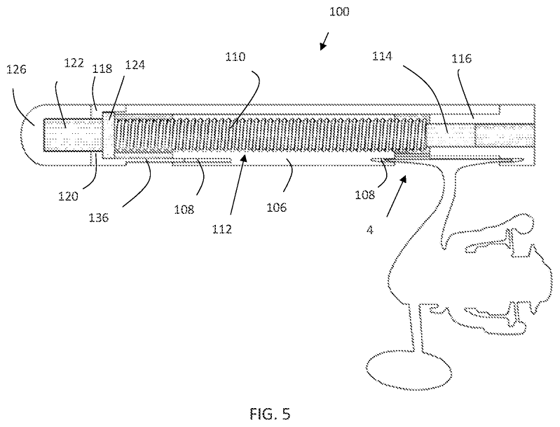

Moving on to FIGS. 4-6, the improved reel seat 100 permits mounting and removal of a fishing reel 1 as follows. Reel seat 100 includes a hollow body 102, within which is an adjusting mechanism 104 configured to move a receiving member 106 longitudinally in a first direction to capture a fishing reel 1 by way of the fishing reel foot 4 and in a second direction to release the foot 4 of the fishing reel 1. Receiving member 106 is preferably shaped to overlay fishing reel foot 4 during capture. As such, receiving member 106 can include a flange or slot 108 that receives foot 4.

In some embodiments, longitudinal movement of receiving member 106 is by way of an adjusting mechanism 104 configured as a threaded rod 110 coupled to a complementary threaded rail 112, which is itself coupled to or forms part of receiving member 106 so that receiving member 106 moves longitudinally as threaded rod 110 rotates, thereby permitting capture or release of fishing reel foot 4. In such embodiments, threaded rod 110 can be rotatably mounted within hollow body 102 by positioning a terminal pin 114 into complementary shouldered sleeve 116 at one end and providing a cap 118 with through bore 120 at the opposing end, which permits passage of a rear extension 122 but prevents passage of dish 124, thereby substantially fixing threaded rod 110 longitudinally. Preferably, the extension 122 together with an external grip 126 forms an actuator 128 that when rotated, causes rotation of the threaded rod 110, which by means of the complementary threaded rail 112, causes receiving member 106 to move longitudinally. In particular, rotation in one direction causes receiving member 106 to close against fishing reel foot 4 and rotation in the opposition direction causes receiving member 106 to move away from fishing reel foot 4.

In in a variation of the above, threaded rod 110 includes two threaded regions that are threaded oppositely, each threaded region coupled to a rail 112 and thus each to a receiving member 106 so that rotation in a first direction causes both receiving members 106 to move towards one another and a rotation in a second direction causes both receiving members 106 to move away from one another.

In embodiments using a threaded rod 110 and rail 112, the spacing of threads can be uniform so that as threaded rod rotates at a fixed velocity, rail continues moves at a uniform rate. However, in other embodiments the spacing of threads can vary to form faster or slower sections such that rail accelerates or decelerates along the length of the threaded rod 110 while the threaded rod 110 rotates at a fixed velocity. In such embodiments, slower sections may be preferred as the fishing reel foot 4 is tightly secured.

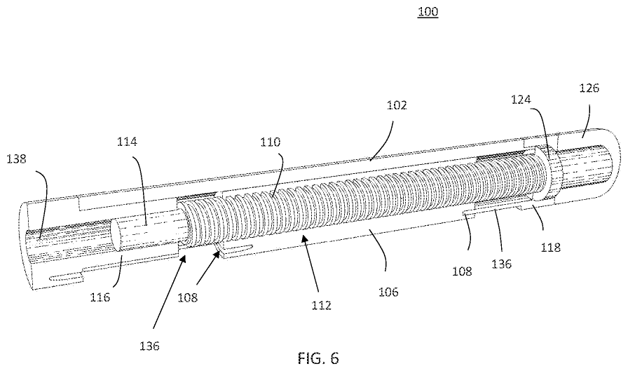

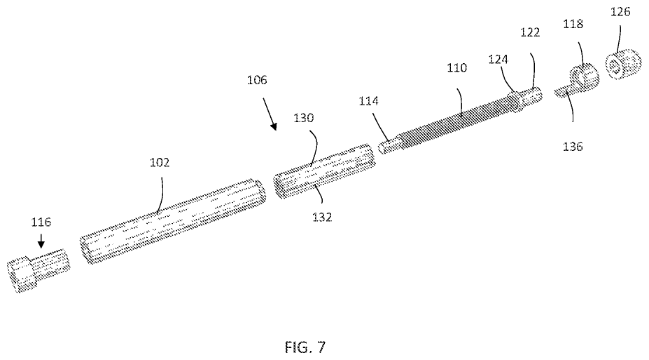

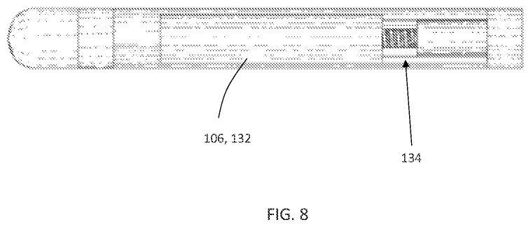

Seen more clearly in FIGS. 6-8, receiving member 106 may itself include a substantially cylindrical base 130 movably positioned within hollow body 102 and through which threaded rod 110 extends. However, in other embodiments, the base is arc-shaped but not entirely cylindrical. Though cylindrical base 130 preferably remains substantially inside hollow body 102, receiving member 106 also preferably includes an outer belly 132 positioned outside of and parallel to cutaway 134 of hollow body 102. Outer belly 132 is preferably slotted 108 or flanged to receive a fishing reel foot 4. Preferably, outer belly 132 is also slotted 108 or flanged to receive a dust cover 136 at the opposing end so that as receiving member 106 longitudinally traverses hollow body 102, dust cover 136 provides a protective barrier over cutaway 134. Dust cover 136 can be formed integral with cap 118 and extend longitudinally.

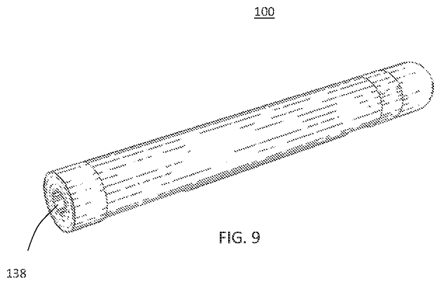

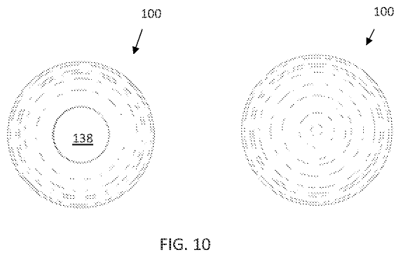

Now with reference to FIGS. 4, 9 and 10, the improved reel seat 100 can be joined with a rod (e.g. fishing rod blank 200) along with any suitable guides to form a fishing rod 2. In particular, blank 200 can be fixedly anchored within aperture 138, such as by way of adhesives, bolting or screwing, or other techniques known in the art to which the invention belongs. In some embodiments, the reel seat 100 also forms a handle of fishing rod 2 and in other embodiments the grip 126 itself forms an elongated handle for fishing rod 2, depending on the desires of the user.

Now with reference to FIGS. 2-10, a fishing reel 1 is secured to the reel seat 100 as follows, fishing reel 1 is positioned so that the fishing reel foot 4 is aligned for receipt by the receiving member 106. Then the receiving member 106 is moved longitudinally against the foot 4 of the fishing reel 1. In instances that include the above-described threaded rod 110, threaded rod 110 is rotated by way of actuator 128 so that the receiving member 106, which includes a complementary threaded rail 112, moves longitudinally against the foot 4 of the fishing reel 1.

What is claimed is:

1. A reel seat for use with a fishing rod, the reel seat comprising:
a) a hollow body;
b) a receiving member shaped to receive a foot of a fishing reel;
c) an adjusting mechanism positioned within the hollow body, the adjusting mechanism configured to move the receiving member longitudinally to capture and release the fishing reel; and
d) an actuator that actuates the adjusting mechanism, wherein the actuator is positioned outside of the hollow body.

2. The reel seat of claim 1, wherein the hollow body forms a handle for a fishing rod.

3. The reel seat of claim 1, configured for attachment to a fishing rod blank.

4. The reel seat of claim 1, wherein the receiving member slides over or under the hollow body along a cutaway.

5. The reel seat of claim 1, wherein the adjusting mechanism comprises a threaded rod configured to rotate within the hollow body and a complementary threaded rail coupled to the receiving member or forming part of the receiving member so that the receiving member moves longitudinally when the threaded rod is rotated.

6. The reel seat of claim 5, wherein the threaded rod is rotatably coupled at one end of the hollow body by means of a pin and sleeve.

7. The reel seat of claim 6, wherein the threaded rod is rotatably coupled at an opposing end by way of a cap with aperture.

8. The reel seat of claim 6, wherein the threaded rod is fixedly coupled to the actuator at an opposing end.

9. The reel seat of claim 1, wherein the actuator comprises an extension fixedly attached to a grip.

10. A fishing rod comprising the reel seat of claim 1 attached to an elongated rod.

11. A method of securing a fishing reel to the reel seat of claim 1, the method comprising:
a) positioning a fishing reel so that the fishing reel foot is aligned for receipt by the receiving member; and
b) actuating the adjustment member by way of the actuator so that the receiving member moves longitudinally against the foot of the fishing reel.

12. A method of securing a fishing reel to the reel seat of claim 5, the method comprising:
a) positioning a fishing reel so that the fishing reel foot is aligned for receipt by the receiving member; and
b) rotating the threaded rod by way of the actuator so that the receiving member moves longitudinally against the foot of the fishing reel.
